(19) United States
(12) Patent Application Publication
(10) Pub. No.: US 2015/0078144 A1
(43) Pub. Date: Mar. 19, 2015

(54) INTEGRATED SMART WATCH

(71) Applicant: Suzhou Lonshine Technologies Co., Ltd., Suzhou (CN)

(72) Inventor: Renxiao Gong, Beijing (CN)

(73) Assignee: Suzhou Lonshine Technologies Co., Ltd., Suzhou (CN)

(21) Appl. No.: 14/176,082

(22) Filed: Feb. 8, 2014

(30) Foreign Application Priority Data
Sep. 18, 2013 (CN) 201310428904.X

(51) Int. Cl. G04C 17/00

(52) U.S. Cl. CPC G04C 17/0041
USPC 368/228

(57) ABSTRACT

An integrated smart watch is provided, which includes a case, a dial plate, a hand, a watch glass and a movement, herein the case is provided with a smart watch circuit board; the watch glass is a transparent display screen, which is electrically connected with a screen connecting end of the smart watch circuit board and has a first state and a second state; in the first state, the watch glass is transparent; and in the second state, the watch glass displays screen content output by the smart watch circuit board. The integrated smart watch and the traditional watch are similar to each other in shape and structure, but the integrated smart watch has the functions of the traditional watch and the smart watch by operatively integrating the traditional watch with the smart watch, which increases the variety of watches.

### CROSS-REFERENCES TO RELATED APPLICATIONS

This application claims the priority to Chinese Patent Application No. 201310428904.X, entitled “INTEGRATED SMART WATCH”, filed with State Intellectual Property Office of PRC on Sep. 18, 2013, which is incorporated herein by reference in its entirety.

### TECHNICAL FIELD

The present invention relates to the technical field of watches, and particularly to an integrated smart watch constituted by a mechanical watch and a smart watch, or a quartz watch and a smart watch.

### BACKGROUND

Watches can be classified into two groups in accordance with power sources: the mechanical watches and the electronic watches. The electronic watches include the digital watches and the quartz watches. In general, the mechanical watches and the quartz watches display the time is by the dial plate and the hand. The mechanical watches and the quartz watches substantially have the same construction except for the movements, and are both referred to as traditional watches in the industry.

Compared with the traditional watch, the smart watch has a lot of additional functions, besides the function of displaying the time. Various applications about sport management, outdoor activities management, health management, human body data gathering and the like, such as a treadmill, compass, an altimeter, a barometer, a multifunctional control handle, a cardiotachometer, a sphygmomanometer, an electrocardiograph, etc., can be implemented, by the intelligent operating system installed in the smart watch combining with the sensors.

In general, the smart watch can be substantially classified into two types: the mobile phone companions and the smart-watch phones with the function of communication.

The mobile phone companion, such as Pebble, Sony Smartwatch, etc., can be paired with a smart phone via Bluetooth to receive e-mails, short massages, update of social network, weather information and the like. However, if there is no smart phone to be paired, the mobile phone companion is only a normal electronic watch.

The smart-watch phone with the function of communication, such as in Watch One released recently by in Watch Tech Ltd, etc., is actually a smart phone which can be used to make calls, receive massages and also can be paired with a smart phone to function as a mobile phone companion.

In general, the traditional watch incorporates with brands, materials, designs and tastes, and thus is luxurious and valuable. On the market, the traditional watches are considered as luxuries and even collection. However, the traditional watch has single function and even for a complex traditional watch, only the functions that are concerned with time are added, such as timing, displaying time of other time zone, lunar calendar, perpetual calendar, and minute repeater. In contrast to the traditional watch, the smart watch, such as Sony Smartwatch, Pebble or I'm Watch, etc., has the functions in terms of electronic, information and network. However, since the smart watch is provided with a TFT or OLED display screen, no matter how cleverly, smartly and multi-functionally the smart watch is designed, it can not be avoided to leave an impression of an electronic watch on a consumer, and the first impression of a customer about these products are electronic watches or electronic devices, but not traditional watches.

Moreover, due to that the smart watch displays time and contents on an OLED or TFT display, the smart watch has a higher power consumption than the traditional watch. In order to achieve power saving, some smart watches are designed to display the time only the smart watch is in a certain state, instead of displaying the time all the time.

It can be seen that the traditional watch and the smart watch each have advantages and disadvantages, and the traditional watch and the smart watch respectively have significantly different market positioning, thus there is no direct competition between them. It will become a significant innovation to design a watch which has the advantages of both the traditional watch and the smart watch.

According to the publication No. CN 1318159A, it is provided a technical solution of a double-face watch. The dial palter of the watch has a double-face structure and can be flipped. In the double-face structure, a first face is provided with a traditional watch, and the other face is provided with an electronic watch. If the electronic watch is replaced by a smart watch, the traditional watch and the smart watch can be integrated into a single watch. In this way, a consumer can optionally use the traditional watch or the smart watch by flipping the dial plate.

However, the watch is actually formed by stacking a mechanical watch and a smart watch back to back. Although the mechanical watch and the smart watch use a same case, the mechanical watch and the smart watch are independent of each other. Hence, it is necessary to design a flipping structure which is special and complex, and the watch needs to be flipped in using. Since the watch is provided with two display screens, thus it is difficult to reduce the overall thickness of the watch, and a higher requirement in manufacturing process is necessary.

As stated above, the technical problem to be solved is how to integrate the traditional watch and the smart watch.

### SUMMARY

The object of the present invention is to provide an integrated smart watch. The integrated smart watch and the traditional watch are similar to each in shape, but the integrated smart watch has functions of the traditional watch and the smart watch by operatively integrating the traditional watch with the smart watch, which increases the variety of watches.

In order to achieve the above object, according to the embodiments of the present invention, it is provided a integrated smart watch, which includes a case, a dial, a hand, a watch glass and a movement, herein the case is provided with a smart watch circuit board;
the watch glass is a transparent display screen, which is electrically connected with a screen connecting end of the smart watch circuit board and is controllable between a first state and a second state;
in the first state, the watch glass is transparent; and
in the second state, the watch glass displays screen contents output by the smart watch circuit board.

Preferably, the transparent display screen is integrated with a touch screen.

Preferably, the movement is a movement of a mechanical watch.

Preferably, the movement of the mechanical watch and the smart watch circuit board are superposed.

Preferably, the movement is a movement of a quartz watch.

Preferably, the movement of the quartz watch and the smart watch circuit board are superposed.

Preferably, the movement of the quartz watch and the smart watch circuit board are integrated on a same circuit board.

Preferably, the integrated smart watch further includes a control device for switching the transparent display screen between the first state and the second state.

Preferably, the control device is provided in the case.

Preferably, the control device is a button switch, a knob switch or a push button switch.

According to the embodiments of the present invention, a watch glass of a traditional watch is replaced by a transparent display screen, and the traditional watch is provided with a smart watch circuit board. The transparent display screen has two states: a transparent state and a display state. In the transparent state, no image is displayed, and the transparent display screen looks like a transparent glass and can be used as a watch glass. In the display state, the display screen can be used as the display screen of the smart watch circuit board, so that the traditional watch is operatively integrated with the smart watch. In the normal state, the integrated smart watch functions as a traditional watch. In this state, the hand of is driven by a watch movement to rotate to indicate the time and a user of the watch can view the hand (such as an hour hand, a minute hand, a second hand) of the watch through the transparent display screen. If the function of the smart watch is needed, the transparent display screen is switched into the display state, on which the corresponding image and information can be displayed.

In a preferable embodiment, a surface of the transparent display screen is provided with a touch screen. Thus, the user can perform operation and control the smart watch via the touch screen on the transparent display screen to implement various functions of the smart watch.

### BRIEF DESCRIPTION OF THE DRAWINGS

FIG. 1 is a structural schematic view of a integrated smart watch according to an embodiment of the present invention; and

FIG. 2 is a top schematic view of FIG. 1 after being rotated.

In figures:

1. case, 2. dial plate, 3. hand, 4. watch glass, 5. mechanical watch movement, 6. smart watch circuit board, 7. touch screen, 8. button switch.

### DETAILED DESCRIPTION

In order to make those skilled in the art better understand the technical solutions of the invention, the present invention is further described in detail hereinafter in conjunction with the drawings and specific embodiments.

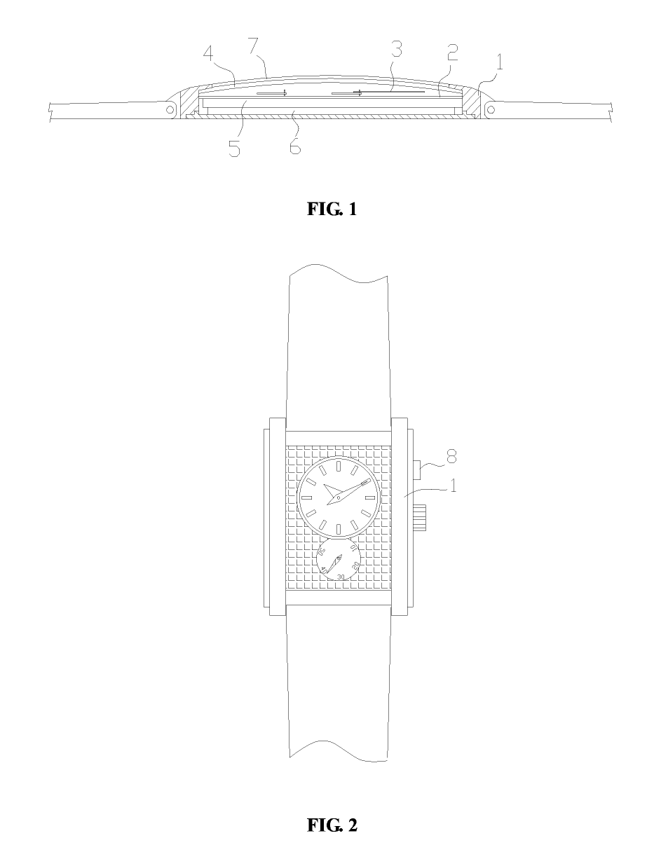

Referring to FIGS. 1 and 2, FIG. 1 is a structural schematic view of an embodiment of a integrated smart watch provided in an embodiment of the present invention; and FIG. 2 is a top schematic view of FIG. 1 after being rotated.

In an embodiment of the present invention, the integrated smart watch is formed to be the same as a mechanical watch in outer shape and construction. The integrated smart watch includes a case 1, a dial plate 2, a hand 3, a watch glass 4 and a mechanical watch movement 5, etc. Furthermore, based on the construction of a mechanical watch, the case 1 is additionally provided with a smart watch circuit board 6, which is superposed under the mechanical watch movement 5.

The watch glass 4 may be formed by a transparent display screen, which is electrically connected with a screen connecting end of the smart watch circuit board 6. The watch glass 4 can be controlled to be in a first state or a second state.

In the first state, the transparent display screen is in a transparent state and no image is displayed on it. In this state, the transparent display screen looks like a piece of transparent glass and can be used as a mirror surface for the dial plate 2; and
in the second state, the transparent display screen is in a displaying state and can display screen contents output by the smart watch circuit board 6. In this state, the transparent display screen can be used as a display screen of the smart watch circuit board 6, so that a traditional watch can be operatively integrated with a smart watch.

In the normal state, the integrated smart watch functions as a mechanical watch. The hand 3 is driven by the mechanical watch movement 5 to rotate to indicate the time. A user of the watch can view the hand 3 (such as an hour hand, a minute hand or a second hand) through the transparent display screen. If the function of a smart watch is needed, the transparent display screen is switched into the display state, on which the corresponding image and information can be displayed.

Further, the transparent display screen is integrated with a touch screen 7 which is electrically connected with the smart watch circuit board 6. In this way, the user can operate and control the smart watch via the touch screen 7 on the transparent display screen to implement various functions of the smart watch.

Specifically, the smart watch circuit board 6 may support the function of caller ID display, the function of a telephone and other various applications, such as an electronic compass, a walking manager, an altimeter, a position indicator, etc., and the smart watch circuit board 6 may support but not be limited to the following wireless communication mode: Bluetooth, WiFi (Wireless Fidelity), NFC (Near Field Communication), etc.

The watch looks like the traditional watch, and is not leave an impression of an electronic watch on the consumer. The watch has the functions of the traditional watch and the smart watch by operatively integrating the traditional watch with the smart watch, thereby the variety of the watch is increased.

Additionally, the integrated smart watch indicates the time by using the movement of the traditional mechanical, and thus the power consumption of the integrated smart watch is lower than that of the existing smart watch.

Of course, besides the movement of the mechanical watch, the movement of the quartz watch can be used in the integrated smart watch. In the case where the movement of the integrated smart watch movement is a movement of the quartz watch, the movement of the integrated smart watch may be integrated with the smart watch circuit board on the same circuit board.

The transparent display screen may be switched between the first state and the second state by a control device. Specifically, the case 1 may be provided with a button switch 8 (which alternatively may be a knob switch or a push button switch). The button switch 8 may control whether the transparent display screen to be energized or deenergized, or control the connecting and disconnecting between the transparent display screen and the smart watch circuit board 6 to achieve the function of switching.

Of course, the above embodiments are only the preferable embodiments of the present invention and will not be limited to this. Various embodiments can be obtained by making corresponding adjustment based on the above embodiments. For example, the case 1, the dial plate 2 and the watch glass 4 of the watch can be designed to be circular; or the smart watch circuit board 6 can be arranged surround the mechanical watch movement 5, and the like. There are so many manners that can be achieved, which will not be illustrated one by one.

Hereinbefore, the integrated smart watch provided in the embodiments of the present invention is introduced in detail. Specific examples are adopted to describe the principle and the embodiments of the present invention. The description of the above embodiments is only used to help understand the method of the invention and the core idea thereof. It should be noted that several modifications and improvements can be made by those skilled in the art without departing from the principle of the invention, and these modifications and improvements should be considered as falling within the scope of protection of the invention claimed in the claims.

1. An integrated smart watch, comprising a case, a dial plate, a hand, a watch glass and a movement, wherein
the case is provided with a smart watch circuit board;
the watch glass is a transparent display screen, which is electrically connected with a screen connecting end of the smart watch circuit board and has a first state and a second state;
in the first state, the watch glass is transparent; and
in the second state, the watch glass displays content output by the smart watch circuit board.

2. The integrated smart watch according to claim 1, wherein the transparent display screen is integrated with a touch screen.

3. The integrated smart watch according to claim 1, wherein the movement is a movement of a mechanical watch.

4. The integrated smart watch according to claim 3, wherein the movement of the mechanical watch movement and the smart watch circuit board are superposed.

5. The integrated smart watch according to claim 1, wherein the movement is a movement of a quartz watch.

6. The integrated smart watch according to claim 5, wherein the movement of the quartz watch and the smart watch circuit board are superposed.

7. The integrated smart watch according to claim 5, wherein the movement of the quartz watch and the smart watch circuit board are integrated in a same circuit board.

8. The integrated smart watch according to claim 1, further comprising a control device for switching the transparent display screen between the first state and the second state.

9. The integrated smart watch according to claim 8, wherein the control device is provided in the case.

10. The integrated smart watch according to claim 9, wherein the control device is a button switch, a knob switch or a push button switch.
